(19) United States
(12) Patent Application Publication
(10) Pub. No.: US 2009/0327259 A1
(43) Pub. Date: Dec. 31, 2009

(54) AUTOMATIC CONCEPT CLUSTERING

(75) Inventor: Andrew Smith, Brisbane (AU)

Correspondence Address: FITZPATRICK CELLA HARPER & SCINTO, 1290 Avenue of the Americas, NEW YORK, NY, 10104-3800, US

(73) Assignee: THE UNIVERSITY OF QUEENSLAND, Brisbane, Queensland (AU)

(21) Appl. No.: 11/911,108

(22) PCT Filed: Apr. 26, 2006
(86) PCT No.: PCT/AU2006/000546

§ 371 Date: Sep. 1, 2009

(30) Foreign Application Priority Data
Apr. 27, 2005 (AU) 2005902090

(51) Int. Cl. G06F 17/30

(52) U.S. Cl. 707/5; 707/E17.109; 707/E17.008

(57) ABSTRACT

A method of identifying thematic groups of nodes by analysis of a corpus of documents. The method uses a distance metric based on connectedness of nodes, which is derived from a co-occurrence measure. The invention is also embodied as a computer-implemented visualization tool that generates a display of nodes and thematic groupings. The invention is useful for ‘data mining’ a large corpus of documents, particularly textual documents, to extract relevant information.

This invention generally relates to a method of data mining a large corpus of textual documents and to visually display extracted information. More particularly, the invention relates to a method of identifying thematic groups of nodes in a network and visualising the thematic grouping. Specifically, these nodes can correspond to concepts, entities, and categories.

### BACKGROUND TO THE INVENTION

The current period of human history has been referred to as the Information Age because of the massive increase in information accessible to the average person. The majority of this available information is stored in computer systems in textual form, for example web pages. While there has been an explosion in the amount of accessible information, there has not been a corresponding improvement in the tools useful for accessing the information. One of the greatest challenges in the information age is to sort the quantity of accessible information to identify the quality information.

One available tool is known as “Leximancer” and is described in detail at www.leximancer.com and in a number of publications including: Automatic Extraction of Semantic Networks from Text using Leximancer. A. E. Smith. In Human Language Technology Conference of the North American Chapter of the Association for Computational Linguistics (HLT-NAACL 2003)—Companion Volume, Edmonton, Alberta, Canada. ACL, 2003, pp Demo23-Demo24; Machine Mapping of Document Collections: the Leximancer system. A. E. Smith. In Proceedings of the Fifth Australasian Document Computing Symposium, Sunshine Coast, Australia. DSTC, 2000; Machine Learning of Well-defined Thesaurus Concepts. A. E. Smith. In Proceedings of the International Workshop on Text and Web Mining (PRICAI 2000), Melbourne, Australia, 2000, pp 72-79. The description of the Leximancer® system is incorporated herein by reference.

Leximancer® operates by transforming lexical co-occurrence information from natural language (contained in documents, web pages, newspaper articles, etc) into semantic patterns in an unsupervised manner. The extracted semantic patterns are displayed by means of a conceptual map that provides an overview of the concepts covered by the documents. The concept map displays five important sources of information about the analysed text:

The main concepts discussed in the document set;

The relative frequency of each concept;

How often concepts co-occur within the text;

The centrality of each concept; and

The similarity in contexts in which the concepts occur.

Leximancer® uses a number of features to assist the user to identify key aspects of the data. The brightness of a concept is related to its frequency (i.e. the brighter the concept, the more often it appears in the text); the brightness of links between concepts relate to how often the two connected concepts co-occur closely within the text; and the nearness in the map indicates that two concepts appear in similar conceptual contexts (i.e. they co-occur with similar other concepts).

A large corpus of documents will result in a very complex map with many concepts and multiple connections between concepts. The Leximancer® user interface allows the user to adjust the number of concepts displayed and to turn off the display of connections between concepts. Nonetheless, it may still be difficult to extract full value from the maps of large sets of documents.

Leximancer® is not the only tool available for extracting information from a large corpus of documents. United States patent application number 2003/0217335, assigned to Verity Inc, describes a method of automatically discovering concepts from a corpus of documents by extracting signatures. Verity defines a signature as a noun or noun-phrase. The similarity between signatures is computed using a statistical measure and a cluster of related signatures, as determined by the statistical measure, defines a concept. The concepts are then built into a hierarchy as a means of visualising key concepts within the corpus. The hierarchical display of Verity is an improvement from the unstructured corpus but falls short of a useful visualisation tool.

A similarity measure, such as determined by Verity and Leximancer®, can be usefully used to provide a graphical display of related concepts. One method is the concept map used by Leximancer® in which the statistical similarity is treated as a distance metric so that the similarity between concepts is related to the distance between concepts on the concept map. There are a number of techniques for calculating a distance metric that can be used to establish a spatial layout of nodes (whether concepts, words, nouns, noun-phrases, etc) in a network.

One such method is Multi Dimensional Scaling (MDS). MDS is a method for projecting a symmetric matrix of node proximities, which is equivalent to a graph with edges, onto a metric space. MDS attempts to faithfully scale the between-node proximities (edge weights) to metric distances between points in the lowest dimensional space possible. The metric space may need to be more than two dimensional to obtain acceptable agreement.

To be more precise, MDS is a particular group of algorithms for achieving this scaling which share certain assumptions—MDS is based around a representation function which directly scales each graph edge weight to a metric distance. The solution is usually found by first calculating the target distance between each pair of nodes using the representation function. Next, random starting locations are assigned and each node is advanced towards its target separation from each other node by fractional increments of the target separation. Often simulated annealing is required to find better solutions. There are other techniques which attempt to achieve similar results by different means. Factor Analysis and Principal Components Analysis decompose the proximity matrix into basis vectors. These being orthogonal provide a multidimensional metric space in which the nodes are located. Solutions found by these methods tend to be in higher dimensional spaces than MDS, and are consequently harder to visualise. For a discussion of these methods, see Modern multidimensional scaling: theory and applications by Ingwer Borg and Patrick Groenen (Springer 1997).

There are other more modern variants of MDS which can be grouped under the name of Force Directed Graphing. These algorithms assign attractive and repulsive force functions of separation distance between nodes. These functions are then used to calculate the energy of a candidate layout of the network. Optimisation methods must still be designed to utilise this fitness function.

Another approach is known as Self Organising Maps (SOM). SOM takes the initial graph and edge weights as input to a competitive neural network which then performs unsupervised clustering of the nodes into a regular low-dimensional grid (normally 2-D). A reference for this method is: Self-Organizing Maps by Teuvo Kohonen, Springer Series in Information Sciences, Vol. 30, Springer, Berlin, Heidelberg, N.Y., 1995, 1997, 2001, 3rd edition.

In broad terms, the prior art techniques for displaying concepts extracted from a corpus of documents fall into two primary groupings, those that display a tree-like structure and those that display a node map. Of these, the map display is more useful for displaying a large number of related nodes. However, as the number of nodes increases the capacity for a user to extract a useful understanding of the concepts in the corpus becomes limited.

### OBJECT OF THE INVENTION

It is an object of the present invention to provide a method of identifying thematic groups of nodes in a network of nodes.

It is also an object of the invention to provide a method of displaying the identified thematic groupings.

Further objects will be evident from the following description.

### DISCLOSURE OF THE INVENTION

In one form, although it need not be the only or indeed the broadest form, the invention resides in a method of identifying a thematic group of nodes including the steps of:

analyzing a corpus of documents to extract nodes;
calculating a location for each node in metric space;
ranking the nodes in order of connectedness; and
allocating each node to a thematic group by determining if a distance in the metric space between the node and a thematic group is less than a boundary parameter distance.

Preferably the distance in the metric space between a node and a group is calculated as the Euclidean distance between the node and the centroid of the group.

A suitable distance is derived from a co-occurrence measure.

### BRIEF DETAILS OF THE DRAWINGS

To assist in understanding the invention preferred embodiments will now be described with reference to the following figures in which:

FIG. 1 is a graphical display of a network of nodes extracted from a corpus of documents;

FIG. 2 is a general depiction of the process from nodes to groups;

FIG. 3 is a flowchart of the method of automatic thematic grouping;

FIG. 4 is the graphical display of FIG. 1 with automatic thematic grouping produced by the invention;

FIG. 5 is the graphical display of FIG. 1 displaying a different boundary parameter; and

FIG. 6 is the graphical display of FIG. 1 displaying another boundary parameter.

### DETAILED DESCRIPTION OF THE DRAWINGS

In describing different embodiments of the present invention common reference numerals are used to describe like features.

In order to exemplify the invention a network map produced by Leximancer® is used. It will be appreciated that the invention is not limited to application with Leximancer® but may be used with any system that produces a network of nodes and having a distance metric defined between the nodes.

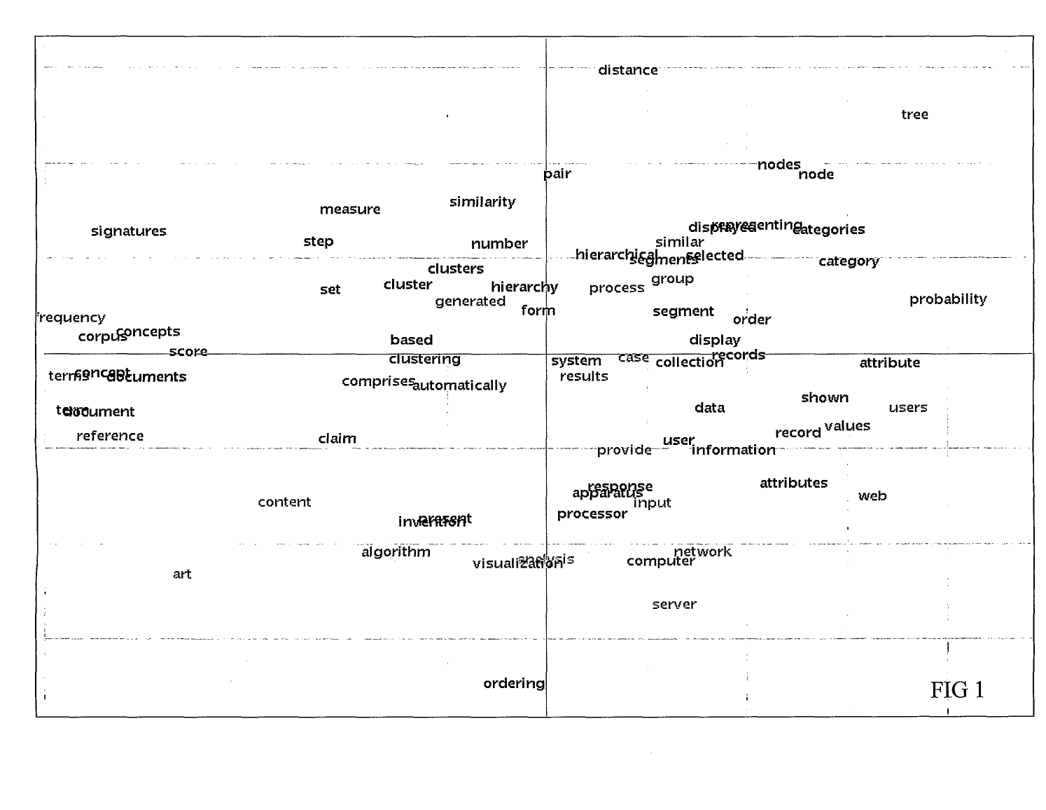

FIG. 1 displays a network map produced by Leximancer® for a corpus of United States patents and patent applications. Each node appearing in the graph is a word representing a concept. Leximancer® automatically learns which words predict which concepts and automatically extracts the concepts from the corpus of documents.

The location of each node on the map is related to contextual similarity between concepts. The map is constructed by initially placing the concepts randomly on the grid. Each concept exerts a pull on each other concept with a strength related to their co-occurrence value. That is, concepts can be thought of as being connected to each other with springs of various lengths. The more frequently two concepts co-occur, the stronger will be the force of attraction (the shorter the spring), forcing frequently co-occurring concepts to be closer on the final map. However, because there are many forces of attraction acting on each concept, it is impossible to create a 2D or 3D map in which every concept is at the expected distance away from every other concept. Rather, concepts with similar attractions to all other concepts will become clustered together. That is, concepts that appear in similar contexts (i.e., co-occur with the other concepts to a similar degree) will appear in similar regions in the map. These regions may be grouped to identify themes.

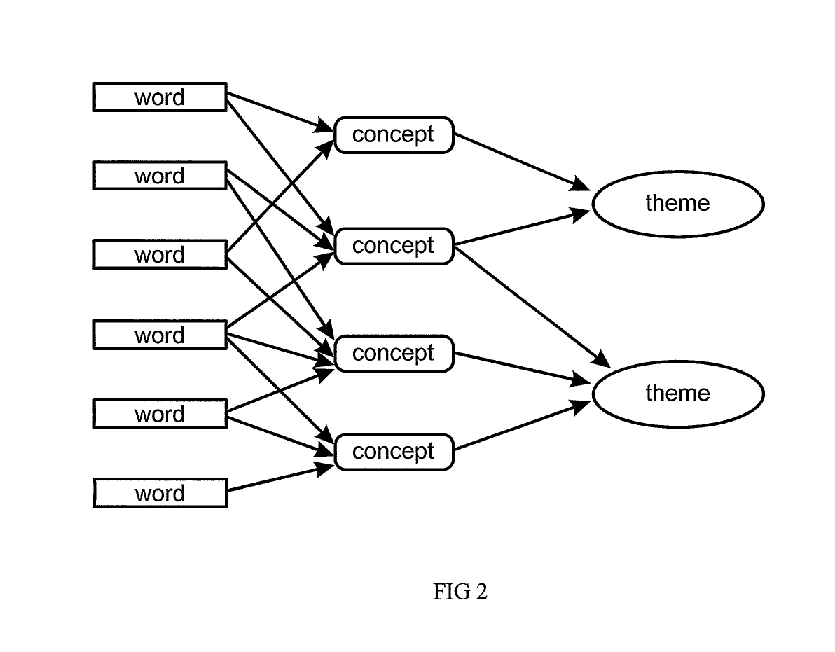

The general concept of moving from words (nodes) to concepts to themes is shown in FIG. 2.

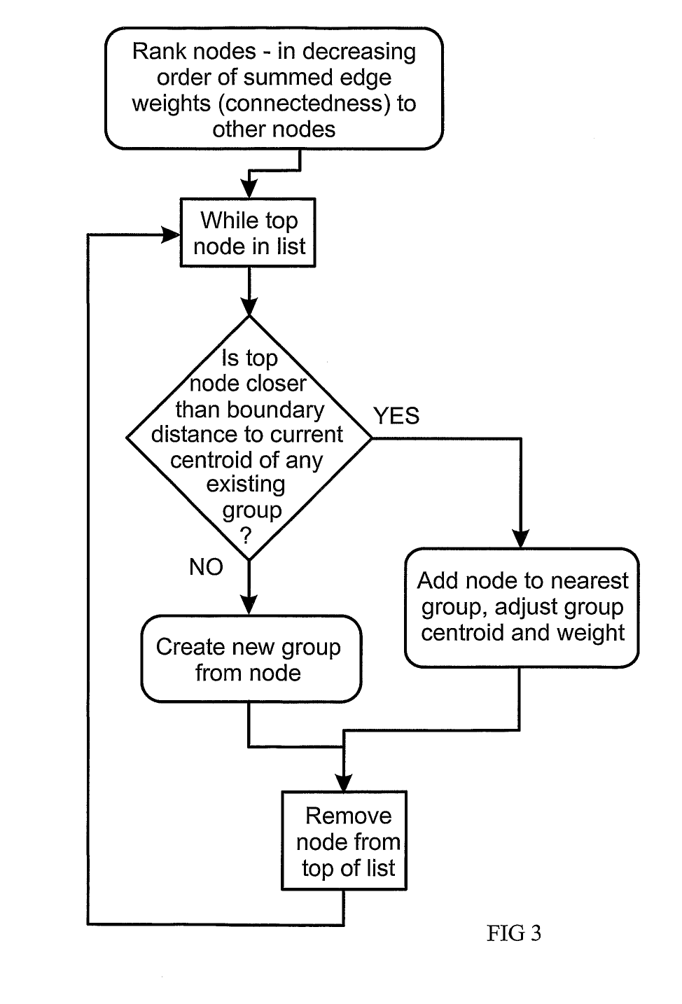

The invention automatically determines a spatial region within which all nodes are considered to be related to the same theme. The boundary parameter distance is a user determined distance on the graph which influences the relative extent of the spatial regions. FIG. 3 displays a flowchart of the process for producing the thematic groups.

The method utilizes the connectedness of nodes in the network to rank them in decreasing order. Connectedness is defined as the sum of all edge values leaving a node in the network. Edges are the concept co-occurrences in the original concept co-occurrence matrix (or network), and are weighted in this instance by the co-occurrence count. An edge is an undirected connection between nodes. Starting at the top of the list of nodes a thematic group is created for the first node. The group centre is initially located at the node. The group is given a connectedness value (weight) which starts as the connectedness of the first member of the group, which is the node with the greatest connectedness.

Moving down the list of ranked nodes, the location of the next node is compared to the centers of all existing groups. If the node is within the fixed predefined distance (called the boundary parameter) of the current group centroid of any groups, the node is placed in the nearest group. When a node is added to a group the centre location of the augmented group is moved to the weighted centroid of the prior group and the added node, where the weight is the connectedness value. The weight of the added node is then added to the weight of the group.

If the next node is not within the boundary parameter distance of any existing group a new group is started.

The node is removed from the list and the process is repeated until the ranked list is exhausted. The result of the process is that all nodes are placed in thematic groups.

The size of each thematic group can be influenced by the user by adjusting the distance defining the boundary parameter. One approach is to set the boundary parameter distance as a percentage of the largest dimension defining the spread of nodes. Thus a boundary of 100% will include all nodes in a single thematic group.

The thematic groups can be visualized by displaying a boundary on the network map around the nodes constituting each group. In the simplest case the boundary will be a circle drawn at a distance from the group centre with a radius equal to the distance to the most remote node that is a member of the group, or the boundary parameter distance, whichever is larger. More complex shapes, such as an ellipse, may be appropriate in some applications. It will be appreciated that higher dimensional spaces will require appropriate spatial regions. For example, a three dimensional space may have a boundary that is a sphere or an ellipsoid.

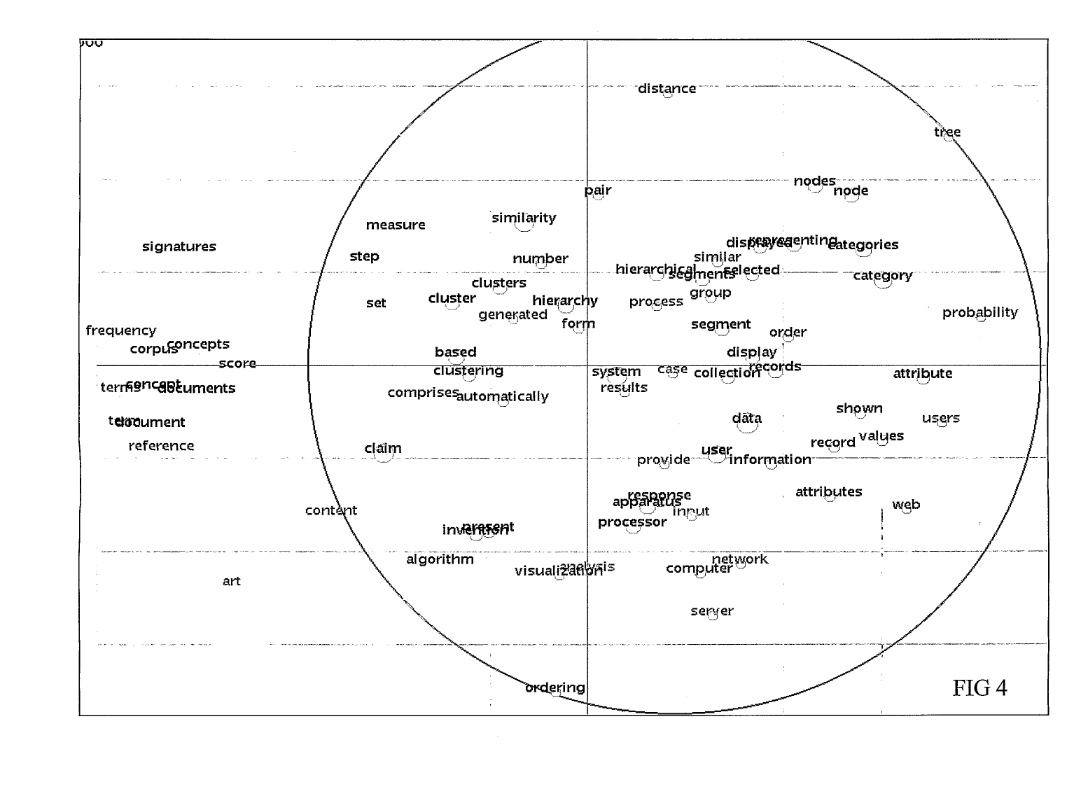

An example of thematic groups drawn using a boundary parameter of 80% of the spread of nodes is displayed in FIG. 4. It will be noted that many nodes belong to two or three thematic groups. This provides useful information about group overlap and therefore the relatedness of themes.

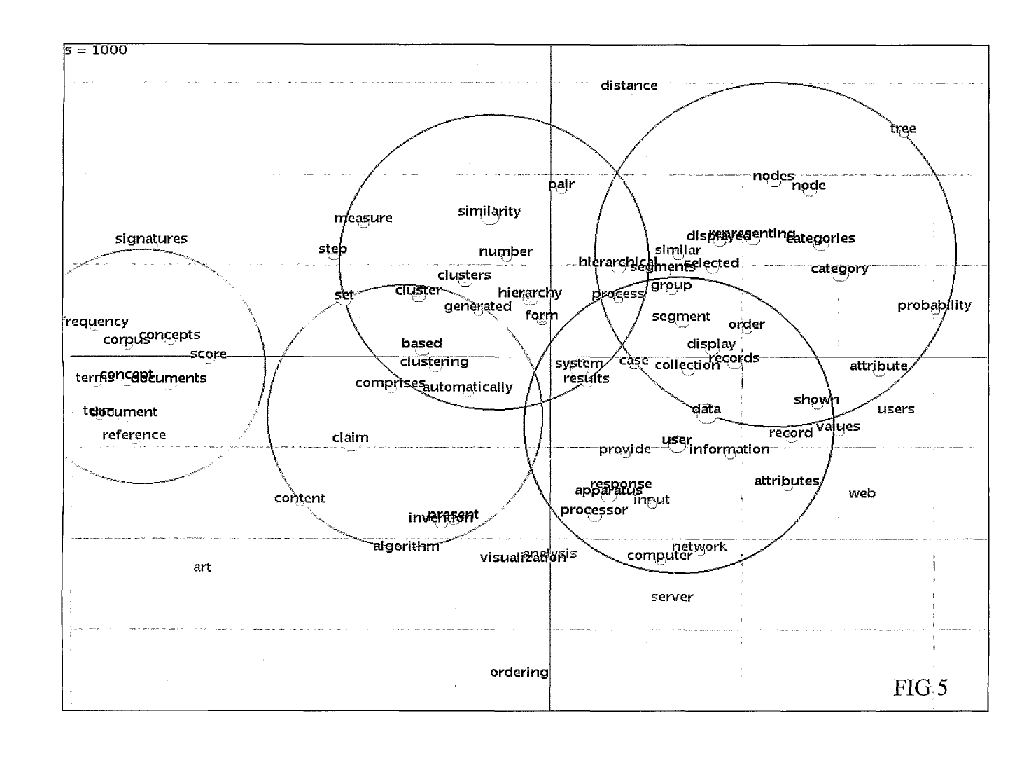

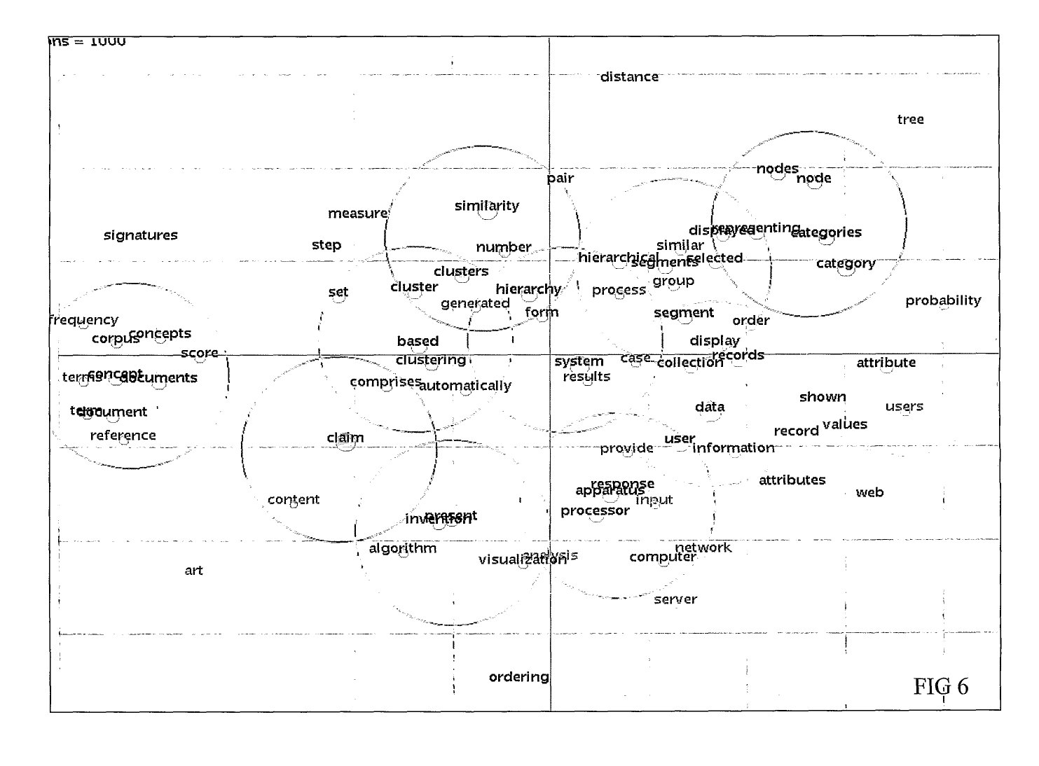

The boundary parameter may be changed to influence the group extent and therefore the coarseness of the thematic grouping. An example of the thematic grouping with half the boundary parameter distance of FIG. 4 is shown in FIG. 5. The invention recalculates the thematic groups from scratch when the boundary parameter distance is changed. FIG. 6 shows the thematic grouping when the boundary parameter distance is again halved compared to FIG. 5. It will be noted that the concept ‘distance’ is contained within the main thematic group in FIG. 4 but has become a separate theme in FIG. 5 and FIG. 6. It will also be noted that the concept ‘similarity’ is towards the periphery of the main group in FIG. 4 but is towards the center of a new group in FIG. 5. In FIG. 6 it appears that ‘similarity’ is near the center of a thematic group. This is showing sub-themes which are subsumed into parent themes at a higher level of abstraction breaking out to form their own separate clusters at a lower level.

In order to provide maximum benefit to the user the invention allows a user to select a group by clicking a mouse pointer within the boundary. Other groups can be hidden to allow the user to focus on the selected thematic group. The nodes within the selected group can be reprocessed at a lower level of abstraction to identify sub-themes. One approach to this reprocessing is to treat the nodes within the selected group as a subnetwork, and recalculate the themes based only on the subnetwork.

Colour coding is also used to assist the group visualization. This is controlled by the aggregate weight of the group as calculated by the algorithm described above. One colour coding option is to display colour using the HSV standard (hue, saturation, value). The hue is correlated with the weight of each group so that a high weight (DATA with a weight of 1 in the following example) will be red and a low weight group will be indigo.

As foreshadowed earlier, an accurate map of connectedness between nodes may require a multi-dimensional space. To render the node map the multi-dimensional space must be reduced to two-dimensional or three-dimensional. Similarly, the thematic grouping can occur in the multi-dimensional space but for display purposes a compromise of accurate depiction of connectedness may be required.

The method depicted in FIG. 3 and discussed above either adds a node to a parent group, or creates a new group from the node, but never both at the same time. In another embodiment of the invention, each node starts a new group whether or not it is added to a parent group, to produce a fully recursive group hierarchy. This results in nodes belonging to parent groups as before, but each node is also a parent of its own group.

Although the thematic grouping of nodes (concepts) on a node map is the preferred visualization technique, it is also possible to display a hierarchical schedule of related concepts by listing thematic groups in order of accumulated connectedness, and within each group listing the constituent concepts in order of connectedness.

The following schedule of concept groups, with group names taken from the most connected member, is produced from the set of patents used to produce the graphical displays described earlier. A printable list of themes and concepts may be more suitable for inclusion in documents or for accessing relevant text in a source document.

Group: DATA (weight 1)

members:
data system user apparatus
response segment display records
processor collection information record
order group results process
case provide input

Group: SIMILARITY (weight: 0.875)

members:
similarity hierarchy based clusters
hierarchical cluster step clustering
set measure pair automatically
number form comprises generated

Group: CATEGORY (Weight: 0.637)

members:
category categories representing node
nodes segments displayed selected
similar order group

Group: CLAIM (Weight: 0.568)

members:
claim based cluster set
clustering step measure automatically
number comprises generated

Group: DOCUMENTS (Weight: 0.428)

members:
documents concept document concepts
corpus signatures score frequency
term terms reference

Group: ATTRIBUTES (Weight: 0.276)

members:
attributes record shown information
values order web users

Group: PRESENT (Weight: 0.26)

members:
present invention automatically comprises
visualization algorithm content analysis

Group: ATTRIBUTE (Weight: 0.241)

members:
attribute shown record values
order web users

Group: COMPUTER 0.141

members:
computer visualization provide network
server input analysis

Group: ORDERING (Weight: 0.089)

members:
ordering visualization algorithm analysis

Group: PROBABILITY (Weight: 0.036)

members:
probability users

Group: DISTANCE (Weight: 0.024)

members:
distance

Group: TREE (Weight: 0.017)

members:
tree

Group: ART (Weight: 0.012)

members:
art

This tree structure is useful for browsing topics and drilling down to relevant documents. If the tree is constructed to be fully recursive each group can break out into subgroups and each node (concept) can be drilled through to related concepts and eventually the source sections of documents.

The example given above is based upon sum of the co-occurrence counts. An alternate approach is to arrange the constituent concepts by relative co-occurrence frequency.

Once thematic groups are displayed it is useful to uniquely name each group. One approach is to allow the user to manually name a group with a term meaningful to them. A preferable approach is to name each thematic group automatically. In one embodiment the automatically assigned name of a thematic group is a concatenation of the most connected concepts within the group. Using the example listing above, it can be seen that the first concept in each group has been used as the group name. Concatenating the first two concepts also gives meaningful labels, for example ‘data system’, ‘similarity hierarchy’, ‘computer visualization’.

The automatic grouping of concepts into themes assists a user to derive meaning from a large corpus of documents without reading all the documents in the corpus. Identified themes of interest can be selected and relevant documents extracted from the corpus for detailed review. The invention is also useful for constructing search strategies to identify documents that will provide relevant information on a concept within a particular theme. Throughout the specification the aim has been to describe the invention without limiting the invention to any particular combination of alternate features.

1. A method of identifying a thematic group of nodes including the steps of:
analyzing a corpus of documents to extract nodes;
calculating a location for each node in a metric space;
ranking the nodes in order of connectedness; and
allocating each node to a thematic group by determining if a current distance in the metric space between the node and a thematic group is less than a boundary parameter distance.

2. The method of claim 1 further including the step of displaying the nodes and the thematic groups on a node map.

3. The method of claim 1 further including the step of displaying the nodes and the thematic groups in a hierarchical schedule.

4. The method of claim 1 wherein the documents in the corpus of documents are textual and the each node is a word representing a concept.

6. The method of claim 4 wherein the step of analyzing includes applying an algorithm that automatically learns which words predict which concepts.

7. The method of claim 4 wherein the step of analyzing includes applying an algorithm that automatically extracts the concepts from the corpus of documents.

8. The method of claim 4 wherein the location for each node is related to contextual similarity between concepts.

9. The method of claim 1 wherein connectedness is calculated as the sum of concept co-occurrences.

10. The method of claim 9 wherein the concept co-occurrences are weighted.

11. The method of claim 1 wherein connectedness is determined from relative co-occurrence frequency.

12. The method of claim 1 wherein the distance in the metric space between a node and a thematic group is calculated as the Euclidean distance between the node and the centroid of the thematic group.

13. The method of claim 1 wherein the distance is derived from a co-occurrence measure.

14. The method of claim 1 wherein the boundary parameter distance is user definable.

15. The method of claim 1 wherein a thematic group is visualized by displaying a boundary around the nodes constituting each group.

16. The method of claim 15 wherein the boundary is a circle drawn at a distance from the group centroid with a radius equal to the distance to the most remote node that is a member of the group or the boundary parameter distance, whichever is larger.

17. The method of claim 15 wherein the boundary is elliptical with user-definable axes.

18. The method of claim 15 wherein the boundary is three dimensional.

19. The method of claim 1 further including the step of applying colour to provide visualization of group properties.

20. The method of claim 19 wherein each thematic group has a weight and the weight correlates to displayed hue of the thematic group.

21. The method of claim 1 wherein each node starts a new thematic group as well as being allocated to a thematic group, thereby producing a fully recursive group hierarchy.

22. A method of identifying documents having a particular theme in a corpus of documents, the method including the steps of:
analyzing the corpus of documents to extract nodes;
calculating a location for each node in a metric space;
ranking the nodes in order of connectedness;
allocating each node to a thematic group by determining if a distance in the metric space between the node and a thematic group is less than a boundary parameter distance; and
drilling down a selected node within a selected theme to identify one or more documents having the particular theme.

23. A computer-implemented tool for visualizing thematic groupings within a corpus of documents, the tool comprising:
a data store containing the corpus of documents;
a processor programmed to perform a series of processing steps on the data store, the processing steps including: analyzing the corpus of documents to extract nodes; calculating a location for each node in a metric space; ranking the nodes in order of connectedness; and
allocating each node to a thematic group by determining if a distance in the metric space between the node and a thematic group is less than a boundary parameter distance; and
a display device exhibiting the nodes and the thematic groupings.

24. The computer-implemented tool of claim 23 further comprising a user input device for inputting the boundary parameter distance as a user adjustable parameter.

25. The computer-implemented tool of claim 24 wherein the thematic groups are visualized on the display device by displaying a boundary around the nodes constituting each group.

26. The computer-implemented tool of claim 25 wherein the boundary is a circle drawn at a distance from the group centroid with a radius equal to the distance to the most remote node that is a member of the group or the boundary parameter distance, whichever is larger.
